(19) United States
(12) Patent Application Publication
(10) Pub. No.: US 2026/0093070 A1
(43) Pub. Date: Apr. 2, 2026

(54) MULTI-LAYER INTEGRATED RING RESONATORS AND WAVEGUIDE INTERCONNECT STACKS

(71) Applicant: Intel Corporation, Santa Clara, CA (US)

(72) Inventors: Veronica STRONG, Hillsboro, OR (US); Georgios C. DOGIAMIS, Chandler, AZ (US); James E. JAUSSI, Hillsboro, OR (US); Feras EID, Chandler, AZ (US); Haisheng RONG, Pleasanton, CA (US); Nada SEKELJIC, Hillsboro, OR (US); Henning BRAUNISCH, Phoenix, AZ (US); Brandon M. RAWLINGS, Chandler, AZ (US); Adel A. ELSHERBINI, Chandler, AZ (US)

(21) Appl. No.: 18/900,024

(22) Filed: Sep. 27, 2024

(51) Int. Cl. G02B 6/293; G02B 6/12

(52) U.S. Cl. CPC G02B 6/29338; G02B 6/12007; G02B 6/29395

(57) ABSTRACT

Embodiments disclosed herein include an apparatus that includes a substrate with a first optical waveguide within the substrate, an optical ring resonator within the substrate, and a second optical waveguide within the substrate. In an embodiment, the first optical waveguide and the second optical waveguide are offset from each other in a vertical direction and a horizontal direction. In an embodiment, the optical ring resonator is between the first optical waveguide and the second optical waveguide in the horizontal direction.

### BACKGROUND

As bandwidth requirements within electronic systems rapidly increase over time, electrical I/O performance and scaling are struggling to keep pace. With electrical I/Os continuing to consume more power to keep up with demands, the amount of energy available for computing functions within the electronic system will be limited. In order to provide a more efficient data transfer solution, the addition of photonics systems (e.g., silicon photonic systems) to form optoelectronic systems is being investigated. For example, photonics systems may provide higher efficiency, lower latency, and higher bandwidths at a reduced power.

The drive towards silicon photonics has also led to new packaging configurations where electrical integrated circuit (EIC) and photonic integrated circuit (PIC) units are combined with 2.5D and 3D stacking architectures. In such architectures, management of optical IO density for both EIC and PIC components with respect to footprint and thermal efficiencies is important. One option is to increase OIO density through vertical stacking. However, this requires the incorporation of modulators, waveguides, and wavelength filters to work in multiple layers within an input unit. This must be done while keeping heating elements and electrical components in a set of limited layers.

### BRIEF DESCRIPTION OF THE DRAWINGS

FIG. 1A is a plan view illustration of a vertical stack ring resonator, in accordance with an embodiment.

FIG. 1B is a cross-sectional illustration of the vertical stack ring resonator in FIG. 1A, in accordance with an embodiment.

FIG. 2A is a plan view illustration of a vertical stack ring resonator with linear input and output waveguides, in accordance with an embodiment.

FIG. 2B is a cross-sectional illustration of the vertical stack ring resonator in FIG. 2A, in accordance with an embodiment.

FIG. 3A is a plan view illustration of a vertical stack ring resonator with a first ring in a first layer and a second ring in a second layer, in accordance with an embodiment.

FIG. 3B is a cross-sectional illustration of the stack ring resonator in FIG. 3A, in accordance with an embodiment.

FIG. 4A is a plan view illustration of a stack ring resonator with an input waveguide in a first layer and two ring resonators and an output waveguide in a second layer, in accordance with an embodiment.

FIG. 4B is a cross-sectional illustration of the stack ring resonator in FIG. 4A, in accordance with an embodiment.

FIG. 5A is a plan view illustration of a stack ring resonator with heating elements adjacent to the ring resonators, in accordance with an embodiment.

FIG. 5B is a cross-sectional illustration of the stack ring resonator in FIG. 5A, in accordance with an embodiment.

FIG. 5C is a cross-sectional illustration of the stack ring resonator in FIG. 5A, in accordance with an additional embodiment.

FIG. 6A is a plan view illustration of a stack ring resonator with a thermoelectric heating element, in accordance with an embodiment.

FIG. 6B is a cross-sectional illustration of the stack ring resonator in FIG. 6A, in accordance with an embodiment.

FIG. 7A is a plan view illustration of a multi-layer double ring resonator, in accordance with an embodiment.

FIG. 7B is a partial perspective view illustration of the multi-layer double ring resonator in FIG. 7A, in accordance with an embodiment.

FIG. 8 is a flow diagram of a process for forming a stack ring resonator, in accordance with an embodiment.

FIG. 9A is cross-sectional illustration of a hybrid bonded optoelectronic system with a stack ring resonator, in accordance with an embodiment.

FIG. 9B is a cross-sectional illustration of an optoelectronic system with a stack ring resonator, in accordance with an embodiment.

FIG. 10 is a schematic of a computing device built in accordance with an embodiment.

### EMBODIMENTS OF THE PRESENT DISCLOSURE

Described herein are optoelectronic systems with multi-layer integrated ring resonators and waveguide interconnect stacks, in accordance with various embodiments. In the following description, various aspects of the illustrative implementations will be described using terms commonly employed by those skilled in the art to convey the substance of their work to others skilled in the art. However, it will be apparent to those skilled in the art that the present disclosure may be practiced with only some of the described aspects. For purposes of explanation, specific numbers, materials and configurations are set forth in order to provide a thorough understanding of the illustrative implementations. However, it will be apparent to one skilled in the art that the present disclosure may be practiced without the specific details. In other instances, well-known features are omitted or simplified in order not to obscure the illustrative implementations.

Various operations will be described as multiple discrete operations, in turn, in a manner that is most helpful in understanding the present disclosure, however, the order of description should not be construed to imply that these operations are necessarily order dependent. In particular, these operations need not be performed in the order of presentation.

Various embodiments or aspects of the disclosure are described herein. In some implementations, the different embodiments are practiced separately. However, embodiments are not limited to embodiments being practiced in isolation. For example, two or more different embodiments can be combined together in order to be practiced as a single device, process, structure, or the like. The entirety of various embodiments can be combined together in some instances. In other instances, portions of a first embodiment can be combined with portions of one or more different embodiments. For example, a portion of a first embodiment can be combined with a portion of a second embodiment, or a portion of a first embodiment can be combined with a portion of a second embodiment and a portion of a third embodiment.

As noted above, optoelectronic systems have the potential to increase the bandwidth of data that can be transmitted between devices while also allowing for more efficient power utilization. Particularly, the use of optical waveguides in order to propagate data in the form of optical signals may allow for the development of complex multi-die systems. However, the integration of such systems is not without issue. For example, 2.5D and/or 3D integrations (e.g., where dies are stacked and communicatively coupled in a vertical direction) may require the ability to propagate optical signals in both the horizontal and vertical directions in order to enable the desired optical coupling between stacked dies.

Accordingly, embodiments disclosed herein may include optical structures that enable vertically oriented optical coupling in order to help drive further chip scaling. Such embodiments may help mitigate loses and provide options for EIC and PIC units to be configured in new ways to help address data bandwidth and power consumption issues that are present in existing multi-die architectures.

In some embodiments described herein, optical coupling in a vertical direction may be enabled through the use of one or more ring resonators that are provided between optical waveguides that are positioned at different levels within a substrate (e.g., within a chip, an interposer, or the like). For example, a first optical waveguide may be positioned at a first level within a substrate and a second optical waveguide may be positioned at a second level within the substrate. In an embodiment, a ring resonator may be positioned between the first optical waveguide and the second optical waveguide. As an optical signal is propagated through the first optical waveguide, the optical signal couples into the ring resonator, and the optical signal can then be coupled into the second optical waveguide from the ring resonator. That is, when a beam of light passes through the first optical waveguide, an evanescence field forms outside of the first optical waveguide, and some portion of the beam of light can couple into the ring resonator when the ring resonator is close enough to the first optical waveguide. Similarly, an evanescence field from the ring resonators can couple a portion of the beam of light into the second optical waveguide. By positioning the first optical waveguide, the ring resonator, and the second optical waveguide in different layers of the substrate, vertical propagation of the optical signal is enabled.

In some embodiments, the ring resonator is in a layer between the first optical waveguide and the second optical waveguide. In other embodiments, the ring resonator may be within the same layer as one of the optical waveguides. Embodiments may also include multiple stacked ring resonators in order to transmit optical signals vertically through a plurality of layers within a substrate.

In yet another embodiment, a ring resonator may be used in order to optically couple optical waveguides that are provided within different substrates. For example, a first optical waveguide may be within a first substrate, and a ring resonator may be at a surface of the first substrate and optically coupled the first optical waveguide. In such an embodiment, the second optical waveguide may be at a surface of a second substrate. When the first substrate is bonded between the second substrate, the ring resonator may optically couple with the second optical waveguide in the second substrate. In this way, a vertical transmission of an optical signal between substrates may be enabled.

More generally, the combination of the different embodiments described herein allows for efficient 2.5D and/or 3D optoelectronic systems. For example, various different types of dies may be optically coupled to each other directly and/or through an interposer. As used herein, “optically coupled” may refer to two components that are capable of transmitting and/or receiving optical signals to/from each other. In some instances, two components may be optically coupled when an optical signal propagates from the first component directly to the second component. Other embodiments may include two optically coupled components that include an intermediary component. For example, an optical signal may be transmitted by a first component into one or more intermediary components, and one of the intermediary components propagates the optical signal to the second component. For example, a first die may be optically coupled to a second die when an optical signal is propagated from the first die to the second die along an optical waveguide that is provided on an interposer that is bonded to both the first die and the second die.

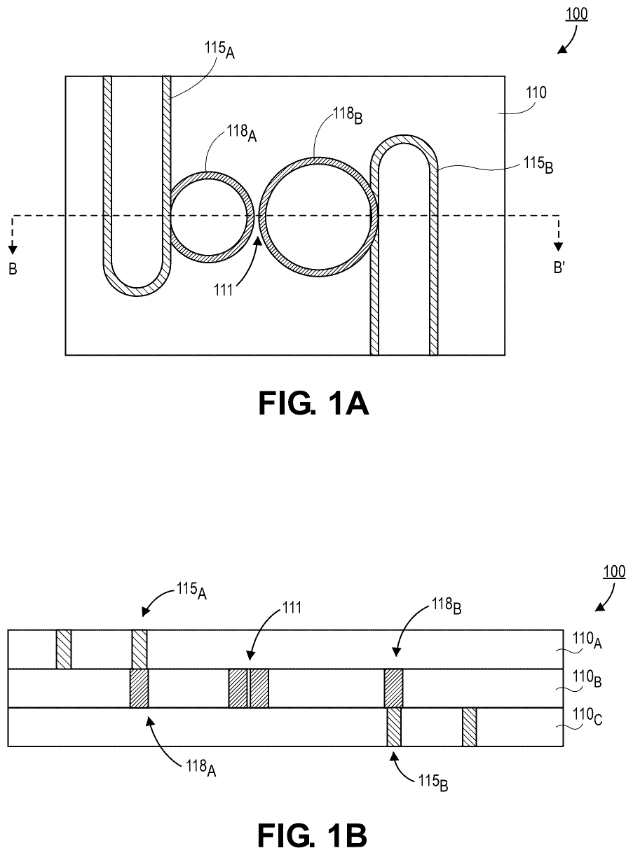

Referring now to FIGS. 1A and 1B, a plan view illustration and a corresponding cross-sectional illustration along line B-B′ of a portion of a substrate 100 is shown, in accordance with an embodiment. In an embodiment, the substrate 100 may comprise any type of die, chip, interposer, or the like. In the illustrated embodiment, the substrate 100 may include one or more layers 110. For example, three layers 110_{A}, 110_{B}, and 110_{C} are shown in FIG. 1B. In an embodiment, the layers 110 may comprise a dielectric material. The dielectric layers 110 may comprise a dielectric material with a relatively low refractive index. For example, the dielectric layers 110 may comprise silicon dioxide, glass, or the like.

The use of low refractive index dielectric materials for the dielectric layers 110 may allow for the layers 110 to be a cladding layer for optical waveguide structures fabricated within the substrate 100. For example, the optical waveguide structures within the substrate 100 may include a first optical waveguide 115_{A}, a second optical waveguide 115_{B}, and a ring resonator 118. In an embodiment, the first optical waveguide 115_{A}, the second optical waveguide 115_{B}, and the ring resonator 118 may comprise dielectric materials with relatively high refractive indexes. More generally, a refractive index of the optical waveguides 115_{A}, 115_{B}, and the ring resonator 118 may be higher than a refractive index of the dielectric layers 110. For example, the first optical waveguide 115_{A}, the second optical waveguide 115_{B}, and/or the ring resonator 118 may comprise a silicon nitride, a silicon oxynitride, a doped silicon oxide, or the like.

In the illustrated embodiment, the ring resonator 118 comprises a first ring 118_{A} and a second ring 118_{B}. As shown, the first ring 118_{A} has a different diameter than the second ring 118_{B}. Though, the first ring 118_{A} and the second ring 118_{B} may have any suitable diameters. Additionally, while two rings 118_{A} and 118_{B} are shown, it is to be appreciated that the ring resonator 118 may comprise a single ring or more than two rings. In the illustrated embodiment, the first ring 118_{A} may be spaced apart from the second ring 118_{B} by a gap 111. Additionally, while shown as having the same shading, the first ring 118_{A} and the second ring 118_{B} may comprise different dielectric materials.

In the illustrated embodiment, the first optical waveguide 115_{A} is spaced apart from the second optical waveguide 115_{B} in both the vertical direction and the horizontal direction. For example, the first optical waveguide 115_{A} is within a first dielectric layer 110_{A}, and the second optical waveguide 115_{B} is within a third dielectric layer 110_{C}. Additionally, the first optical waveguide 115_{A} is offset from the second optical waveguide 115_{B} so that no portion of the first optical waveguide 115_{A} overlaps a portion of the second optical waveguide 115_{B}.

The ring resonator 118 provides the optical coupling between the first optical waveguide 115_{A} and the second optical waveguide 115_{B}. For example, the ring resonator 118 may be provided within the second dielectric layer 110_{B} between (in the vertical direction) the first optical waveguide 115_{A} and the second optical waveguide 115_{B}.

Additionally, the ring resonator 118 may be between (in the horizontal direction) the first optical waveguide 115_{A} and the second optical waveguide 115_{B}. In the particular embodiment, shown in FIG. 1B, a portion of the first optical waveguide 115_{A} overlaps a portion of the ring resonator (e.g., the first ring 118_{A}), and a portion of the second optical waveguide 115_{B} overlaps a portion of the ring resonator (e.g., the second ring 118_{B}). As such, a portion of the evanescence field of the first optical waveguide 115_{A} that extends down into the second layer 110_{B} is coupled into the first ring 118_{A} of the ring resonator 118, and an evanescence field of the second ring 118_{B} extends down into the second optical waveguide 115_{B} within the third layer 110_{C}. Similarly, the optical coupling can occur in reverse from the second optical waveguide 115_{B} up into the ring resonator 118, and from the ring resonator 118 into the first optical waveguide 115_{A}. Accordingly, optical coupling in the vertical direction is enabled without the need for vertically oriented optical waveguides.

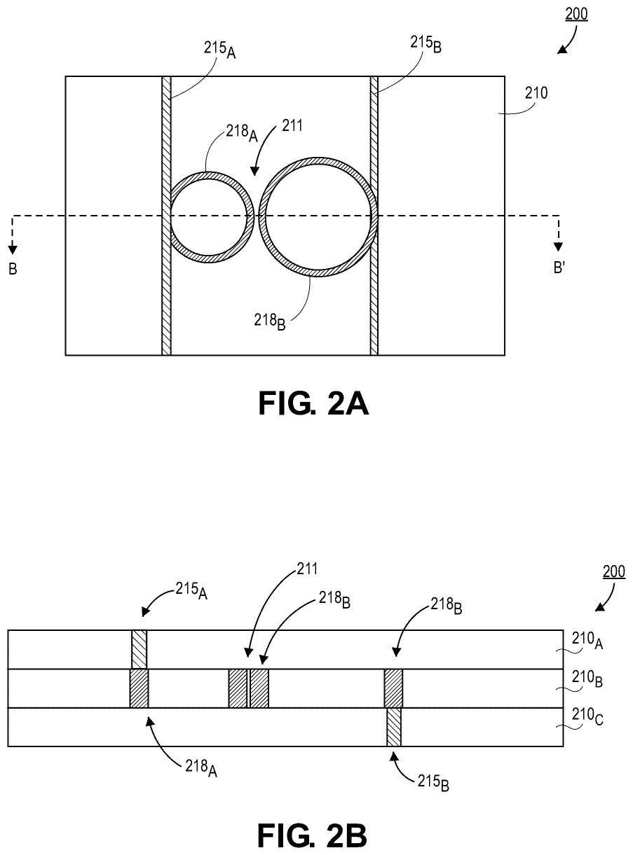

In the embodiment shown in FIG. 1A, the first optical waveguide 115_{A} and the second optical waveguide 115_{B} have curves or turns proximate to the ring resonator 118. Though, it is to be appreciated that the first optical waveguide 115_{A} and the second optical waveguide 115_{B} may have any suitable layout. Such an example is shown in FIGS. 2A and 2B.

Referring now to FIGS. 2A and 2B, a plan view illustration and a corresponding cross-sectional illustration along line B-B′ of a substrate 200 is shown, in accordance with an embodiment. In an embodiment, the substrate 200 may be similar to the substrate 100, with the exception of the shape of the first optical waveguide 215_{A} and the second optical waveguide 215_{B}. For example, the substrate 200 may comprise a dielectric layer 210 that comprises a plurality of layers 210_{A}, 210_{B}, and 210_{C}. In an embodiment, the first optical waveguide 215_{A} may be provided in the first layer 210_{A}, and the second optical waveguide 215_{B} may be provided in the third layer 210_{C}. In an embodiment, the ring resonator 218 may include a first ring 218_{A} that is spaced apart from a second ring 218_{B} by a gap 211.Though, the first ring 218_{A} and the second ring 218_{B} may not be spaced apart by a gap 211 in other embodiments. The ring resonator 218 may be provided within the second layer 210_{B} between the first optical waveguide 215_{A} and the second optical waveguide 215_{B} (in both the horizontal and vertical directions).

As shown, the first optical waveguide 215_{A} and the second optical waveguide 215_{B} may be substantially linear in the area proximate to the ring resonator 218. In an embodiment, the first optical waveguide 215_{A} may overlap the first ring 218_{A}, and the second ring 218_{B} may overlap the second optical waveguide 215_{B}.

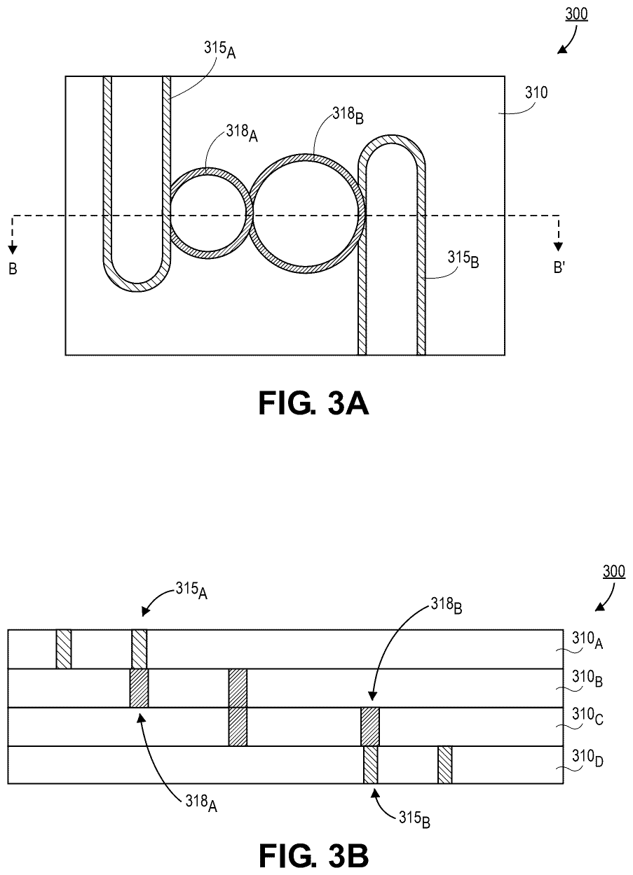

Referring now to FIGS. 3A and 3B, a plan view illustration and a corresponding cross-sectional illustration along line B-B′ of a substrate 300 is shown, in accordance with an embodiment. In an embodiment, the substrate 300 may be similar to the substrate 100, with the exception of the shape of the layout of the ring resonator 318. For example, the substrate 300 may comprise a dielectric layer 310 that comprises a plurality of layers 310_{A}, 310_{B}, 310_{C}, and 310_{D}. In an embodiment, the first optical waveguide 315_{A} may be provided within the first layer 310_{A}, and the second optical waveguide 315_{B} may be provided within the fourth layer 310_{D}. Instead of having the ring resonator 318 in a single layer, the ring resonator 318 may be split between two layers. For example, the first ring 318_{A} may be provided in the second layer 310_{B}, and the second ring 318_{B} may be provided in the third layer 310_{C}. In an embodiment, the first ring 318_{A} overlaps a portion of the second ring 318_{B}. Splitting the ring resonator 318 into different layers allows for even further vertical propagation of the optical signal compared to previous embodiments described herein.

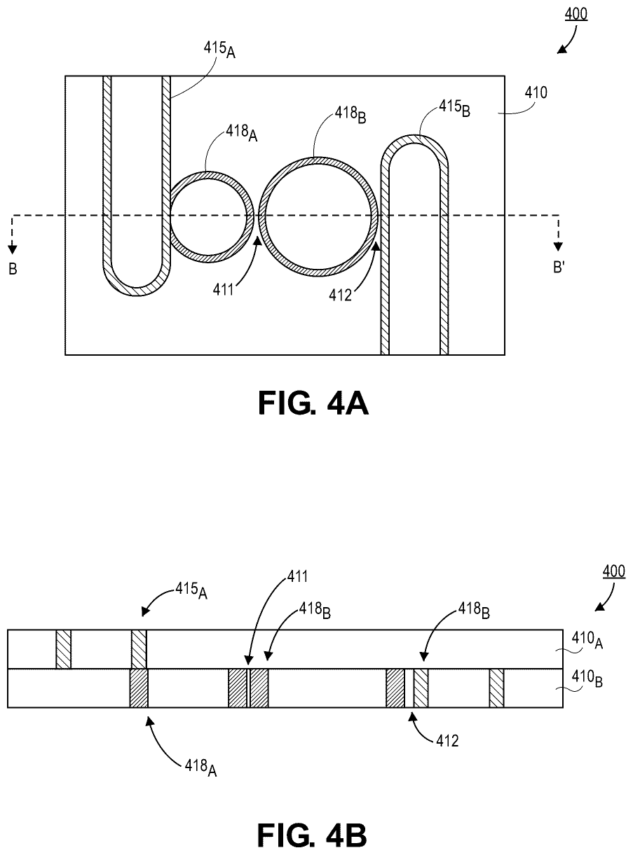

Referring now to FIGS. 4A and 4B, a plan view illustration and a corresponding cross-sectional illustration along line B-B′ of a substrate 400 is shown, in accordance with an embodiment. In an embodiment, the substrate 400 may be similar to the substrate 100, with the exception of the positioning of the first optical waveguide 415_{A} and the second optical waveguide 415_{B}. For example, the substrate 400 may comprise a dielectric layer 410 that comprises a pair of layers 410_{A} and 410_{B}. As shown, the ring resonator 418 may include a first ring 418_{A} that is spaced away from a second ring 418_{B} by a gap 411. However, instead of having the second optical waveguide 415_{B} below the ring resonator 418, the second optical waveguide 415_{B} is in the second layer 410_{B} and spaced apart from the second ring 418_{B} by a gap 412. Such an embodiment allows for transmitting an optical signal in a vertical direction through a single layer instead of multiple layers. Its should also be noted that the presence of a gap 412 is optional depending on design rules and material selection.

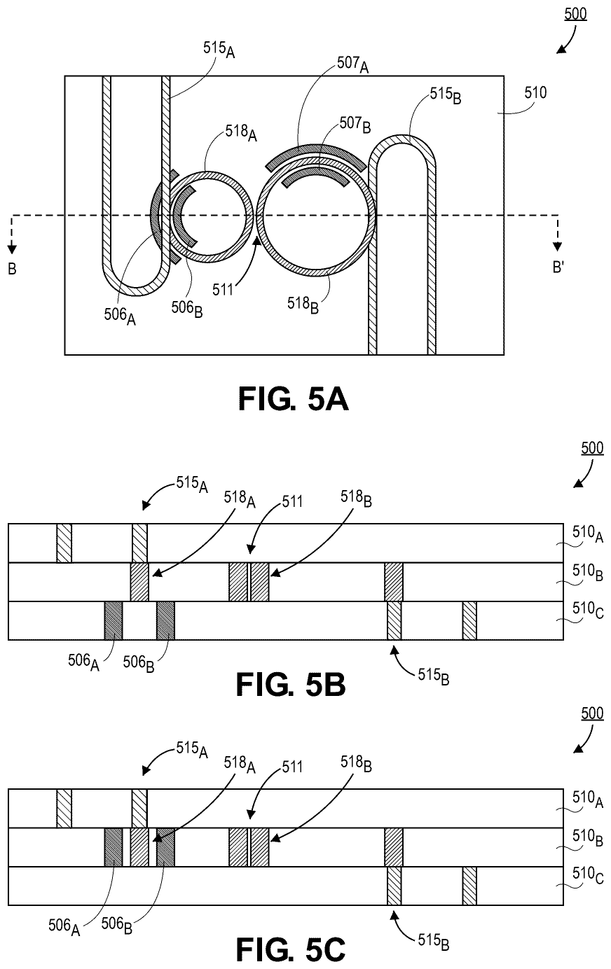

Referring now to FIGS. 5A and 5B, a plan view illustration and a corresponding cross-sectional illustration along line B-B′ of a substrate 500 is shown, in accordance with an embodiment. In an embodiment, the substrate 500 may be similar to the substrate 100, with the addition of heating elements 506 and/or 507 that are adjacent to the first ring 518_{A} and the second ring 518_{B}, respectively, of the ring resonator 518. That is, the substrate 500 may comprise a dielectric layer 510 that comprises a plurality of layers 510_{A}, 510_{B}, and 510_{C}. In an embodiment, the first optical waveguide 515_{A} may be provided in the first layer 510_{A}, and the second optical waveguide 515_{B} may be provided in the third layer 510_{C}. In an embodiment, the ring resonator 518 may include a first ring 518_{A} that is spaced apart from a second ring 518_{B} by a gap 511. The ring resonator 518 may be provided within the second layer 510_{B} between the first optical waveguide 515_{A} and the second optical waveguide 515_{B} (in both the horizontal and vertical directions).

In an embodiment, the heating element 506 may include an outer element 506_{A} outside of the first ring 518_{A} and an inner element 506_{B} inside of the first ring 518_{A}. In an embodiment, the heating element 507 may include an outer element 507_{A} outside of the second ring 518_{B} and an inner element 507_{B} inside of the second ring 518_{B}. Though, the positioning of the heating elements 506 and 507 may be provided at any suitable location in order to modify a temperature of the ring resonator 518. As shown in FIG. 5B, the heating element 506 is formed in the third layer 510_{C}. Though, in other embodiments, the heating element 506 may be provided within the same layer as the first ring 518_{A} (e.g., in the second layer 510_{B}), as shown in the cross-sectional illustration of FIG. 5C. The heating element 506 may also be provided in the first layer 510_{A} over the first ring 518A. Similarly, the heating element 507 may be provided in the first layer 510_{A}, the second layer 510_{B}, or the third layer 510_{C}.

In an embodiment, the heating elements 506 and 507 may include resistive heating elements. For example, the heating elements 506 and 507 may comprise a conductive material, such as copper, aluminum, or the like. The heating elements 506 and 507 may be coupled to electrical circuits (not shown) that provide current to the heating elements 506 and 507 in order to generate heat that can be coupled into one or both of the first ring 518_{A} and/or the second ring 518_{B}. Controlling a temperature of one or both of the first ring 518_{A} and/or the second ring 518_{B} may allow for control of the wavelength of light that is propagated through the ring resonator 518 between the first optical waveguide 515_{A} and the second optical waveguide 515_{B}.

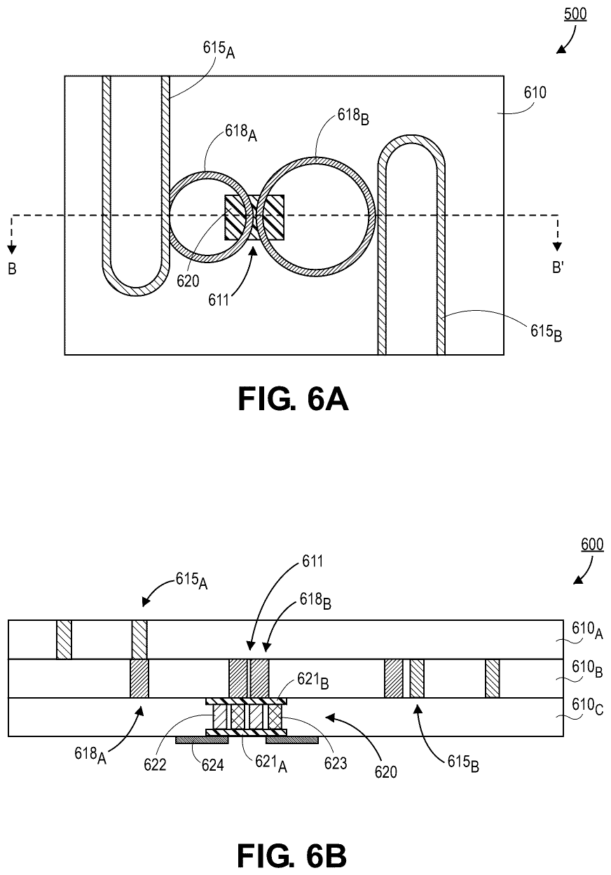

Referring now to FIGS. 6A and 6B, a plan view illustration of a substrate 600 and a corresponding cross-sectional illustration of the substrate 600 along a line B-B′ is shown, in accordance with an embodiment. In an embodiment, the substrate 600 may comprise a first optical waveguide 615_{A} that is optically coupled to a second optical waveguide 615_{B} through a ring resonator 618 that includes a first ring 618_{A} and a second ring 618_{B}. The first optical waveguide 615_{A} may be in a first layer 610_{A} of the substrate 600, and the first ring 618_{A}, the second ring 618_{B}, and the second optical waveguide 615_{B} may be provided in a second layer 610_{B}.

In an embodiment, a thermoelectric heater 620 may be provided in one of the layers 610 of the substrate 600. For example, the thermoelectric heater 620 is provided in a third layer 610_{C} below a portion of the first ring 618_{A} and the second ring 618_{B}. For example, the thermoelectric heater 620 may span a gap 611 between the first ring 618_{A} and the second ring 618_{B}. In an embodiment, the thermoelectric heater 620 may comprise ceramic layers 621_{A} and 621_{B} that are coupled together by alternating P-type semiconductor pillars 622 and N-type semiconductor pillars 623. Electrical contacts 624 (e.g., copper contacts) may be provided below the ceramic layer 621A in order to provide electrical current to the thermoelectric heater 620. While a single thermoelectric heater 620 is provided below both the first ring 618_{A} and the second ring 618_{B}, other embodiments may include a first thermoelectric heater 620 below the first ring 618_{A} and a second thermoelectric heater 620 below the second ring 618_{B}. Also, while the thermoelectric heater 620 is shown below the ring resonator 618, other embodiments may include one or more thermoelectric heaters over the ring resonator 618. Other embodiments, may include a first thermoelectric heater 620 over the ring resonator 618 and a second thermoelectric heater 620 under the ring resonator 618.

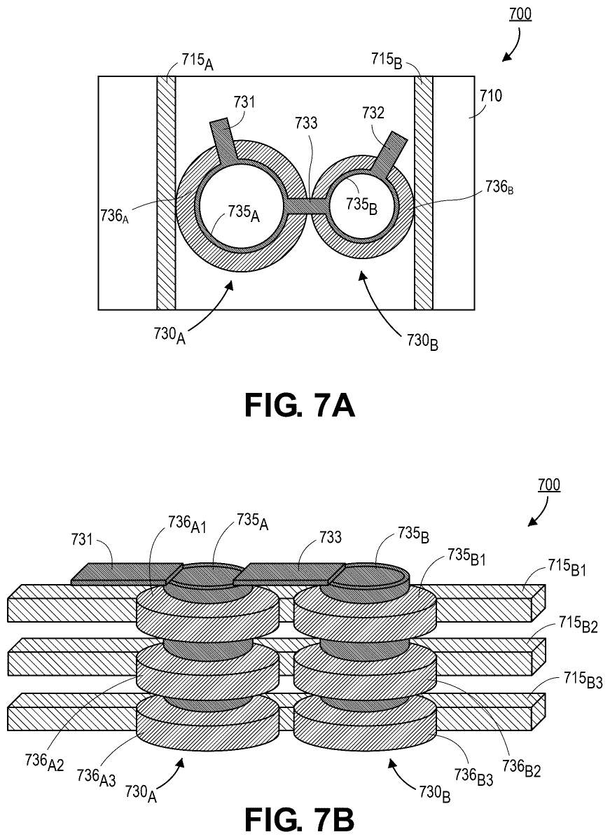

Referring now to FIG. 7A, a plan view illustration of a substrate 700 with a multi-layer double ring oscillator is shown, in accordance with an embodiment. FIG. 7B is a partial perspective view illustration of the multi-layer double ring oscillator, in accordance with an embodiment. As shown, a first stack 730_{A} of rings 736_{A1}-736_{A3} are coupled together by a first conductive shell 735_{A}, and a second stack 730_{B} of rings 736_{B1}-736_{B3} are coupled to each other by a second conductive shell 735_{B}. In an embodiment, an electrical bridge 733 may electrically couple the first conductive shell 735_{A} to the second conductive shell 735_{B}. An electrical input 731 may be electrically connected to the first conductive shell 735_{A}, and an electrical output 732 may be electrically coupled to the second conductive shell 735_{B}.

In an embodiment, a first stack of optical waveguides 715_{A} may be provided adjacent to the first stack 730_{A} of rings 736_{A1}-736_{A3}, and a second stack of optical waveguides 715_{B} may be provided adjacent to the second stack 730_{B} of rings 736_{B1}-736_{B3}. In an embodiment, the second stack of optical waveguides 715_{B1}-715_{B3} may be provided in different layers 710 of the substrate 700. The first stack of optical waveguides 715_{A} (which are omitted from FIG. 7B for clarity) may be provided in different layers 710 of the substrate 700.

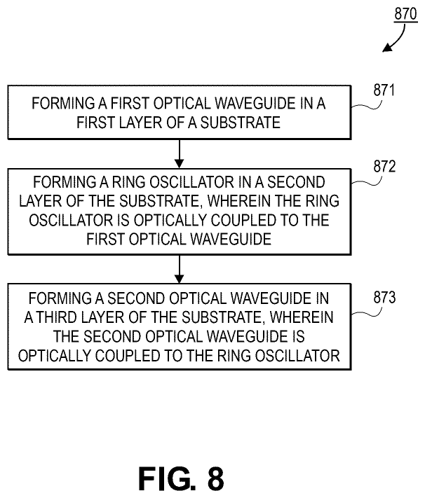

Referring now to FIG. 8, a flow diagram of a process 870 for forming a structure for optically coupling waveguides between layers in a substrate is shown, in accordance with an embodiment. In an embodiment, the process 870 may begin with operation 871, which comprises forming a first optical waveguide in a first layer of the substrate. In an embodiment, the first optical waveguide may be formed by patterning a trench into the first layer, and filling the trench with a dielectric material that has a higher index of refraction than the dielectric material of the first layer.

In an embodiment, the process 870 may continue with operation 872, which comprises forming a ring oscillator in a second layer of the substrate. In an embodiment, the ring oscillator is optically coupled to the first optical waveguide. In an embodiment, the ring oscillator may be a double ring resonator, a single ring resonator, or any other ring resonator structure described in greater detail herein. While described as being formed in the second layer, the ring oscillator may also be formed in the first layer. In an embodiment, the ring oscillator may overlap a portion of the first optical waveguide.

The ring oscillator may be formed with a process similar to the process used to form the first optical waveguide. For example, the ring oscillator may be formed by making a ring-shaped trench into the dielectric material of the second layer, and filling the trench with a dielectric material that has an index of refraction that is higher than the index of refraction of the dielectric material of the second layer.

In an embodiment, the process 870 may continue with operation 873, which comprises forming a second optical waveguide in a third layer of the substrate. In an embodiment, the second optical waveguide is optically coupled to the ring oscillator. For example, the second optical waveguide may overlap a portion of the ring oscillator. Also, while described as being in the third layer of the substrate, other embodiments may include the second optical waveguide being formed in the second layer so that the second optical waveguide is adjacent to the ring oscillator. In an embodiment, the second optical waveguide may be formed by forming a trench into the dielectric material of the third layer of the substrate. The trench may be filled with a dielectric material that has an index of refraction that is higher than the index of refraction of the dielectric material of the third layer of the substrate.

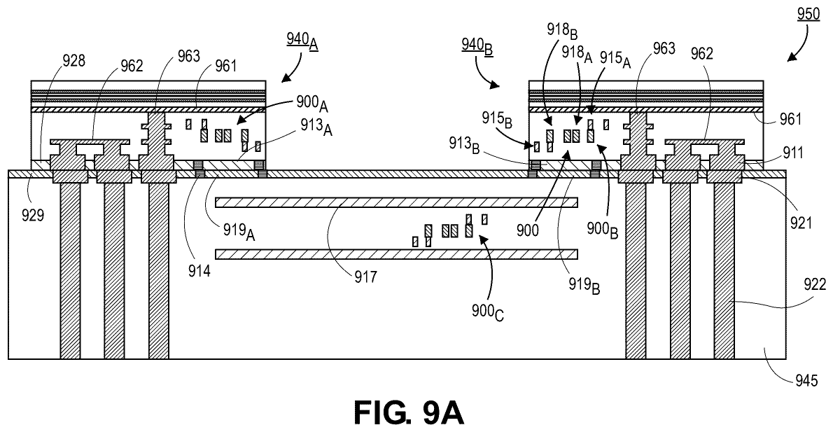

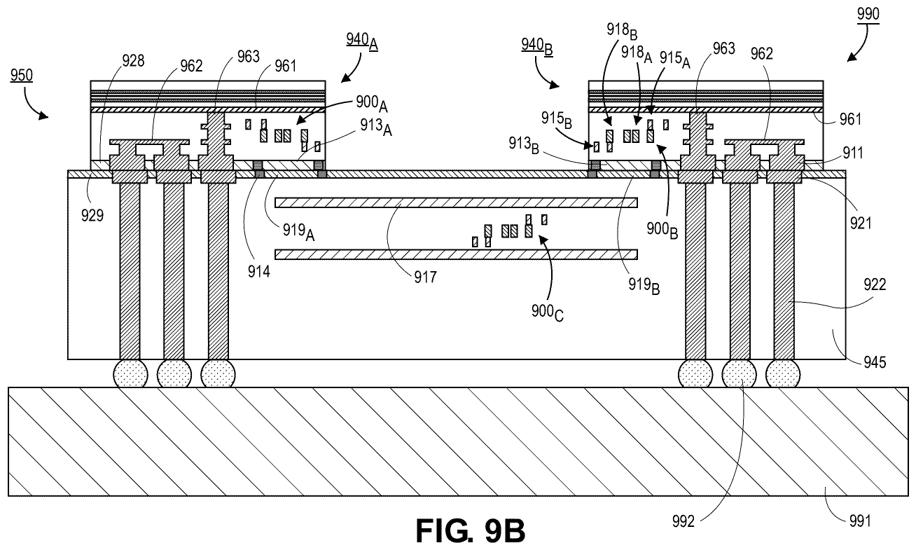

Referring now to FIG. 9A, a cross-sectional illustration of an optoelectronic device 950 is shown, in accordance with an embodiment. As shown, the optoelectronic device 950 may comprise one or more substrates 940 (e.g., 940_{A} and 940_{B}) that are hybrid bonded to an additional substrate 945. In an embodiment, the substrates 940_{A} and 940_{B} may be dies, such as monolithic and/or quasi-monolithic chips. For example, the substrates 940_{A} and 940_{B} may comprise an xPU, a memory device, a switch, a controller, or the like. The substrate 945 may comprise an interposer, such as an electro-optical interposer. For example, the substrate 945 may be monolithic or disaggregated. The substrate 945 may be a wafer-level substrate, a panel level substrate, a single reticle die size, a multi-reticle die size, or the like.

In an embodiment, the substrates 940_{A} and 940_{B} may comprise a device layer 961, which comprises transistor devices and/or the like. In an embodiment, electrical interconnects (e.g., vias 963, traces 962, pads 911, and/or the like) may electrically couple the device layer 961 to electrical pads 921 and/or vias 922 in the substrate 945. For example, pads 911 may be directly bonded to pads 921 in a hybrid bonding process. Dielectric optical waveguides 913_{A} and 913_{B} may be provided over surfaces of the substrates 940_{A} and 940_{B} within dielectric layer 928 in order to provide dielectric-to-dielectric bonding interfaces with dielectric optical waveguides 919_{A} and 919_{B} that are within a dielectric layer 929 of the substrate 945. In an embodiment, gaps 914 may be provided along the dielectric layers 928 to define the optical waveguides 913_{A} and 913_{B} on the substrates 940_{A} and 940_{B} and in dielectric layer 929 in order to define optical waveguides 919_{A} and 919_{B} on the substrate 945. The optical waveguides 913_{A} and 919_{A} may be directly bonded to each other at the hybrid bonding interface, and the optical waveguides 913_{B} and 919_{B} may be directly bonded to each other at the hybrid bonding interface.

In an embodiment, vertical optical coupling structures 900_{A} and 900_{B} may be embedded within the substrates 940_{A} and 940_{B}, respectively. In an embodiment, each of the vertical optical coupling structures 900_{A} and 900_{B} may comprise a first optical waveguide 915_{A} that is optically coupled to a ring resonator (e.g., a first ring 918_{A} and a second ring 918_{B}) and a second optical waveguide 915_{B}. In an embodiment, the first optical waveguide 915_{A} and the second optical waveguide 915_{B} are vertically separated from each other in different layers of the substrates 940_{A} or 940_{B}. In some embodiments, the first optical waveguide 915_{A} and the second optical waveguide 915_{B} are also separated from each other in a horizontal direction. Similarly, one or more vertical optical coupling structures 900_{C} may be embedded within the substrate 945. For example, the vertical optical coupling structure 900_{C} may be provided between one or more additional optical waveguides 917 within the substrate 945.

In an embodiment, vertical optical coupling structure 900_{B} may be optically coupled to one of the optical waveguides 917 by the interface optical waveguides 913_{B} and 919_{B} which may also function as a vertical optical coupling structure. Similarly, vertical optical coupling structure 900_{A} may be optically coupled to one of the optical waveguides 917 through a vertical optical coupling structure formed by interface optical waveguides 913_{A} and 919_{A}. In this way the substrate 940_{A} is optically coupled to the substrate 940_{B} through the substrate 945.

In other embodiments, vertical optical coupling structures 900 may replace the interface optical waveguides 913_{A} and 919_{A} in order to provide optical coupling across a hybrid bonded interface. For example, the first optical waveguide 915_{A} may be formed in the dielectric layer 928 of the substrate 940_{A}, the ring resonator 918 may be formed in the dielectric layer 929 of the substrate 945, and the second optical waveguide 915_{B} may be formed in the substrate 945 below the dielectric layer 929. A similar structure may be provided across the interface between the substrate 940_{B} and the substrate 945. Accordingly, high data bandwidths with efficient power consumption may be enabled between the substrates 940_{A} and 940_{B}.

Referring now to FIG. 9B, a cross-sectional illustration of an optoelectronic system 990 is shown, in accordance with an embodiment. In an embodiment, the optoelectronic system 990 may comprise a board 991, such as a printed circuit board (PCB), a motherboard, or the like. In an embodiment, an optoelectronic device 950 is coupled to the board 991 by interconnects 992. The interconnects 992 may be any suitable second level interconnect (SLI), such as solder bumps, sockets, or the like.

In an embodiment, the optoelectronic device 950 may be similar to any of the devices described in greater detail herein. For example, the optoelectronic device 950 may comprise a pair of substrates 940_{A} and 940_{B} that are hybrid bonded to an interposer substrate 945. In an embodiment, the substrates 940_{A} and 940_{B} may include vertical optical coupling structures 900 that include ring resonators 918 between optical waveguides 915_{A} and 915_{B}. The vertical optical coupling structures 900 may be formed entirely within a single substrate (e.g., 940_{A}, 940_{B}, and/or 945), or the vertical optical coupling structures 900 may be split across a hybrid bonding interface between two substrates 940_{A}, 940_{B}, and/or 945. As such, the substrate 940_{A} may be optically coupled to the substrate 940_{B} through the substrate 945. More generally, the optoelectronic device 950 may comprise a 2.5D or 3D structure with hybrid bonded interfaces that comprises metal-to-metal interconnects for electrical coupling and vertical optical coupling structures for vertical optical coupling between substrates 940 and/or 945.

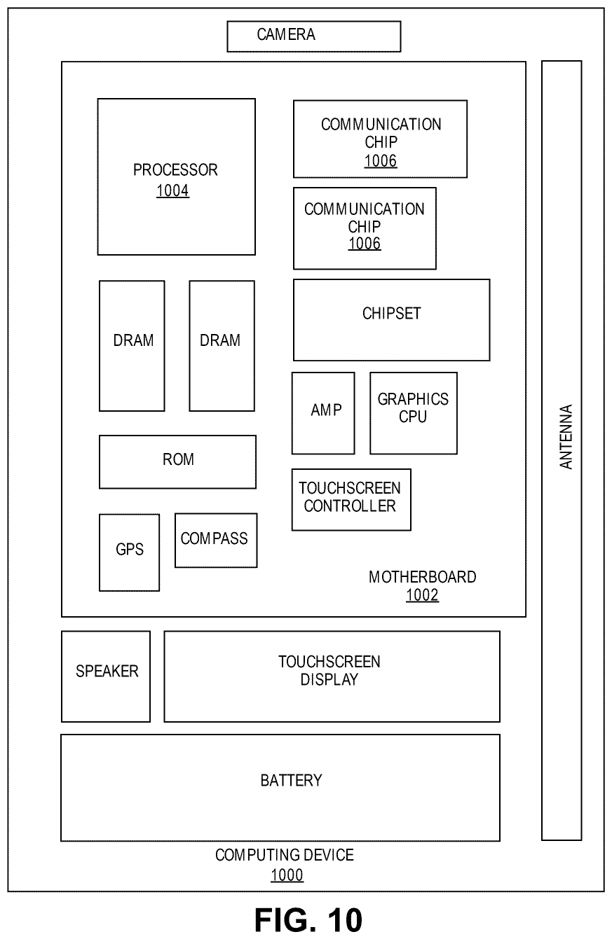

FIG. 10 illustrates a computing device 1000 in accordance with one implementation of the disclosure. The computing device 1000 houses a board 1002. The board 1002 may include a number of components, including but not limited to a processor 1004 and at least one communication chip 1006. The processor 1004 is physically and electrically coupled to the board 1002. In some implementations the at least one communication chip 1006 is also physically and electrically coupled to the board 1002. In further implementations, the communication chip 1006 is part of the processor 1004.

These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 1006 enables wireless communications for the transfer of data to and from the computing device 1000. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1006 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 1000 may include a plurality of communication chips 1006. For instance, a first communication chip 1006 may be dedicated to shorter range wireless communications such as Wi-Fi and Bluetooth and a second communication chip 1006 may be dedicated to longer range wireless communications such as GPS, EDGE, GPRS, CDMA, WiMAX, LTE, Ev-DO, and others.

The processor 1004 of the computing device 1000 includes an integrated circuit die packaged within the processor 1004. In some implementations of the disclosure, the integrated circuit die of the processor may be part of an optoelectronic system with multi-layer integrated ring resonators and waveguide interconnect stacks, in accordance with embodiments described herein. The term “processor” may refer to any device or portion of a device that processes electronic data from registers and/or memory to transform that electronic data into other electronic data that may be stored in registers and/or memory.

The communication chip 1006 also includes an integrated circuit die packaged within the communication chip 1006. In accordance with another implementation of the disclosure, the integrated circuit die of the communication chip may be part of an optoelectronic system with multi-layer integrated ring resonators and waveguide interconnect stacks, in accordance with embodiments described herein.

In an embodiment, the computing device 1000 may be part of any apparatus. For example, the computing device may be part of a personal computer, a server, a mobile device, a tablet, an automobile, or the like. That is, the computing device 1000 is not limited to being used for any particular type of system, and the computing device 1000 may be included in any apparatus that may benefit from computing functionality.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above detailed description. The terms used in the following claims should not be construed to limit the disclosure to the specific implementations disclosed in the specification and the claims. Rather, the scope of the disclosure is to be determined entirely by the following claims, which are to be construed in accordance with established doctrines of claim interpretation.

Example 1: an apparatus, comprising: a substrate; a first optical waveguide within the substrate; an optical ring resonator within the substrate; and a second optical waveguide within the substrate, wherein the first optical waveguide and the second optical waveguide are offset from each other in a vertical direction and a horizontal direction, and wherein the optical ring resonator is between the first optical waveguide and the second optical waveguide in the horizontal direction.

Example 2: the apparatus of Example 1, wherein the optical ring resonator is between the first optical waveguide and the second optical waveguide in the vertical direction.

Example 3: the apparatus of Example 1 or Example 2, wherein the optical ring resonator comprises a first ring and a second ring.

Example 4: the apparatus of Example 3, wherein the first ring and the second ring are at a same height within the substrate in the vertical direction.

Example 5: the apparatus of Example 3, wherein the first ring and the second ring are at different heights within the substrate in the vertical direction.

Example 6: the apparatus of Examples 1-5, wherein the first optical waveguide overlaps the first ring, and wherein the second optical waveguide overlaps the second ring.

Example 7: the apparatus of Examples 1-6, wherein the first ring overlaps the second ring.

Example 8: the apparatus of Examples 1-7, wherein the first optical waveguide and the second optical waveguide comprise one or more of a composition comprising silicon and nitrogen, a composition comprising silicon, oxygen, and nitrogen, or a composition comprising silicon, oxygen, and a dopant.

Example 9: the apparatus of Examples 1-8, wherein the optical ring resonator is configured to optically couple the first optical waveguide to the second optical waveguide.

Example 10: the apparatus of Examples 1-9, further comprising: a heating element adjacent to the optical ring resonator.

Example 11: an apparatus, comprising: a first layer; a first optical waveguide in the first layer; a second layer; a second optical waveguide in the second layer; and an optical ring resonator between the first optical waveguide and the second optical waveguide, wherein the optical ring resonator is configured to optically couple the first optical waveguide to the second optical waveguide.

Example 12: the apparatus of Example 11, wherein the optical ring resonator is between the first layer and the second layer.

Example 13: the apparatus of Example 11 or Example 12, wherein the optical ring resonator overlaps one or both of the first optical waveguide or the second optical waveguide.

Example 14: the apparatus of Examples 11-13, further comprising: a heating element adjacent to the optical ring resonator.

Example 15: the apparatus of Example 14, wherein the heating element comprises a resistive heater or a thermoelectric heater.

Example 16: the apparatus of Examples 11-14, wherein the apparatus is bonded to a second apparatus, and wherein the apparatus is optically coupled to the second apparatus.

Example 17: the apparatus of Example 16, wherein the apparatus is a die, and wherein the second apparatus is an interposer.

Example 18: an apparatus, comprising: a first substrate with a first optical waveguide; a second substrate bonded to the first substrate, wherein the second substrate comprises a second optical waveguide; and an optical ring resonator within the first substrate, wherein the optical ring resonator optically couples the first optical waveguide to the second optical waveguide.

Example 19: the apparatus of Example 18, wherein the first substrate is a die and the second substrate is an interposer.

Example 20: the apparatus of Example 18 or Example 19, wherein the first substrate is hybrid bonded to the second substrate.

What is claimed is:

1. An apparatus, comprising:
a substrate;
a first optical waveguide within the substrate;
an optical ring resonator within the substrate; and
a second optical waveguide within the substrate, wherein the first optical waveguide and the second optical waveguide are offset from each other in a vertical direction and a horizontal direction, and wherein the optical ring resonator is between the first optical waveguide and the second optical waveguide in the horizontal direction.

2. The apparatus of claim 1, wherein the optical ring resonator is between the first optical waveguide and the second optical waveguide in the vertical direction.

3. The apparatus of claim 1, wherein the optical ring resonator comprises a first ring and a second ring.

4. The apparatus of claim 3, wherein the first ring and the second ring are at a same height within the substrate in the vertical direction.

5. The apparatus of claim 3, wherein the first ring and the second ring are at different heights within the substrate in the vertical direction.

6. The apparatus of claim 3, wherein the first optical waveguide overlaps the first ring, and wherein the second optical waveguide overlaps the second ring.

7. The apparatus of claim 3, wherein the first ring overlaps the second ring.

8. The apparatus of claim 1, wherein the first optical waveguide and the second optical waveguide comprise one or more of a composition comprising silicon and nitrogen, a composition comprising silicon, oxygen, and nitrogen, or a composition comprising silicon, oxygen, and a dopant.

9. The apparatus of claim 1, wherein the optical ring resonator is configured to optically couple the first optical waveguide to the second optical waveguide.

10. The apparatus of claim 1, further comprising:
a heating element adjacent to the optical ring resonator.

11. An apparatus, comprising:
a first layer;
a first optical waveguide in the first layer;
a second layer;
a second optical waveguide in the second layer; and
an optical ring resonator between the first optical waveguide and the second optical waveguide, wherein the optical ring resonator is configured to optically couple the first optical waveguide to the second optical waveguide.

12. The apparatus of claim 11, wherein the optical ring resonator is between the first layer and the second layer.

13. The apparatus of claim 11, wherein the optical ring resonator overlaps one or both of the first optical waveguide or the second optical waveguide.

14. The apparatus of claim 11, further comprising:
a heating element adjacent to the optical ring resonator.

15. The apparatus of claim 14, wherein the heating element comprises a resistive heater or a thermoelectric heater.

16. The apparatus of claim 11, wherein the apparatus is bonded to a second apparatus, and wherein the apparatus is optically coupled to the second apparatus.

17. The apparatus of claim 16, wherein the apparatus is a die, and wherein the second apparatus is an interposer.

18. An apparatus, comprising:
a first substrate with a first optical waveguide;
a second substrate bonded to the first substrate, wherein the second substrate comprises a second optical waveguide; and
an optical ring resonator within the first substrate, wherein the optical ring resonator optically couples the first optical waveguide to the second optical waveguide.

19. The apparatus of claim 18, wherein the first substrate is a die and the second substrate is an interposer.

20. The apparatus of claim 18, wherein the first substrate is hybrid bonded to the second substrate.
